(19) United States
(12) Patent Application Publication
(10) Pub. No.: US 2012/0127488 A1
(43) Pub. Date: May 24, 2012

(54) Image Forming Apparatus and Image Forming Method

(75) Inventor: Hiroomi Nakatsuji, Osaka (JP)

(73) Assignee: Kyocera Mita Corporation

(21) Appl. No.: 13/292,592

(22) Filed: Nov. 9, 2011

(30) Foreign Application Priority Data
Nov. 19, 2010 (JP) 2010-259422

(51) Int. Cl. G06F 3/12

(52) U.S. Cl. 358/1.1

(57) ABSTRACT

An image forming apparatus has: (a) a character-area identifying unit that identifies a character area in image data, and (b) a screen processing unit that performs a screen process of an area in the image data other than the character area by using a first dot growth pattern, and performs a screen process of the character area by using a second dot growth pattern different from the first dot growth pattern.

### CROSS-REFERENCE TO RELATED APPLICATION

This application relates to and claims priority rights from a Japanese Patent Application: No. 2010-259422, filed on Nov. 19, 2010, the entire disclosures of which are hereby incorporated by reference herein.

### BACKGROUND OF THE INVENTION

1. Field of the Invention

This invention relates to image forming apparatuses and image forming methods.

2. Description of the Related Art

A character area often occupies a large portion of an image printed by an image forming apparatus such as printer or multifunction peripheral. Since the character area has many edge portions, due to the edge effect the character area consumes toner more than a gradation area such as photograph at the same coverage rate.

A copier thins out pixels, thins a line constituting a character or changes a solid character to an outline character in order to reduce the toner consumption of the character area.

### SUMMARY OF THE INVENTION

However, reducing the toner consumption as mentioned above results in low quality of the print image.

Although detecting an edge portion of the character and changing a pixel value in the edge portion may reduce the toner consumption, a complicated process is required for the exact detection of the edge portion and the appropriate change of the pixel value.

This invention has been made in view of the aforementioned circumstances. It is an object to the present invention to provide image forming apparatuses and image forming methods capable of reducing the toner consumption without detecting the edge portion so as not to lower the quality of a print image.

The present invention solves this subject as follows.

An image forming apparatus according to an aspect of the present invention has: (a) a character-area identifying unit that identifies a character area in image data, and (b) a screen processing unit that performs a screen process of an area in the image data other than the character area by using a first dot growth pattern, and performs a screen process of the character area by using a second dot growth pattern different from the first dot growth pattern.

Therefore, performing the screen process by using the second dot growth pattern suitable for characteristics of the character area, the toner consumption can be reduced without detecting any edge portions so as not to lower the quality of the print image.

An image forming method according to an aspect of the present invention has the steps of: (a) identifying a character area in image data, and (b) performing a screen process of an area in the image data other than the character area by using a first dot growth pattern, and a screen process of the character area by using a second dot growth pattern different from the first dot growth pattern.

Therefore, performing the screen process by using the second dot growth pattern suitable for characteristics of the character area, the toner consumption can be reduced without detecting any edge portions so as not to lower the quality of the print image.

These and other objects, features and advantages of the present invention will become more apparent upon reading of the following detailed description along with the accompanied drawings.

### BRIEF DESCRIPTION OF THE DRAWINGS

FIG. 1 is a side view that partially shows a mechanical internal configuration of an image forming apparatus in Embodiment 1 according to this invention;

FIG. 2 is a block diagram that partially shows an electronic configuration of the image forming apparatus in Embodiment 1 according to this invention;

FIG. 3 is a diagram that explains a relation between a pixel value in the image data and the print image data after the screen process of the first dot growth pattern in Embodiment 1 according to this invention;

FIG. 4 is a diagram that explains a relation between a pixel value in the image data and the print image data after the screen process of the second dot growth pattern in Embodiment 1 according to this invention;

FIGS. 5A to 5C are diagrams that explain turning on and off the light irradiated by the exposure device to the photoconductor drum in Embodiment 1 according to this invention; and

FIG. 6 is a diagram that explains a relation between a pixel value in the image data and the print image data after the screen process of the second dot growth pattern in Embodiment 2 according to this invention.

### DETAILED DESCRIPTION OF THE PREFERRED EMBODIMENT

Hereinafter, embodiments according to aspects of the present invention will be explained with reference to drawings.

### Embodiment 1

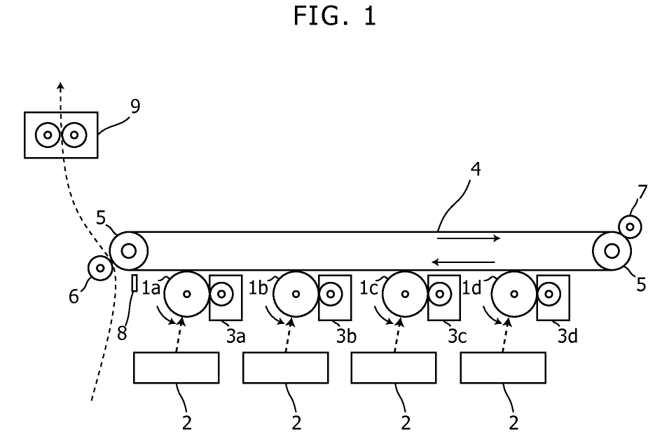

FIG. 1 is a side view that partially shows a mechanical internal configuration of an image forming apparatus in Embodiment 1 according to this invention. The image forming apparatus is an apparatus having a printing function such as printer, facsimile apparatus, copier, or multifunction peripheral.

The image forming apparatus in this embodiment has a tandem-type color development device. This color development device has photoconductor drums 1a to 1d, exposure devices 2, and development units 3a to 3d. The photoconductor drums 1a to 1d are four color photoconductors of Cyan, Magenta, Yellow and Black. The photoconductor drums 1a to 1d may be made from amorphous silicon.

The exposure devices 2 are devices that scan laser beams on the photoconductor drums 1a to 1d to form electrostatic latent images, respectively. The laser beams are scanned in the direction (i.e. primary scanning direction) vertical to the rotation direction (i.e. secondary scanning direction) of the photoconductor drums 1a to 1d. The exposure devices 2 have laser diodes as light sources of the laser beams, and laser scanning units that contain optical elements (such as lens, mirror and polygon mirror) and guide the laser beams to the photoconductor drums 1a to 1d.

Further, in the periphery of the photoconductor drums 1a to 1d, charging units such as scorotron, cleaning devices, static electricity eliminators and so on are disposed. The cleaning devices remove residual toner on the photoconductor drums 1a to 1d after primary transfer. The static electricity eliminators eliminate static electricity of the photoconductor drums 1a to 1d after primary transfer.

The development units 3a to 3d have toner containers filled with four color toner of Cyan, Magenta, Yellow and Black, respectively, and make the toner adhere to electrostatic latent images on the photoconductor drums 1a to 1d, so that toner images are formed. In the development units 3a to 3d, a developer is composed of the toner and a carrier with an external additive such as titanium dioxide.

The photoconductor drum 1a and the development unit 3a perform development of Magenta. The photoconductor drum 1b and the development unit 3b perform development of Cyan. The photoconductor drum 1c and the development unit 3c perform development of Yellow. The photoconductor drum 1d and the development unit 3d perform development of Black.

The intermediate transfer belt 4 is an image carrier and loop-shaped intermediate transfer member, and contacts the photoconductor drums 1a to 1d. Toner images on the photoconductor drums 1a to 1d are primarily transferred onto the intermediate transfer belt 4. The intermediate transfer belt 4 is hitched round driving rollers 5, and rotates by driving force of the driving rollers 5 towards the direction from the contact position with the photoconductor drum 1d to the contact position with the photoconductor drum 1a.

A transfer roller 6 makes a paper sheet being conveyed contact the intermediate transfer belt 4, and secondarily transfers the toner images from the intermediate transfer belt 4 to the paper sheet. The paper sheet on which the toner images have been transferred is conveyed to a fixer 9, and consequently, the toner image is fixed on the paper sheet.

A roller 7 has a cleaning brush, and removes residual toner on the intermediate transfer belt 4 by contacting the cleaning brush to the transfer belt 4 after transferring the toner images to the paper sheet.

A sensor 8 irradiates light to the intermediate transfer belt 4, and detects the reflection light from a surface of the intermediate transfer belt 4 or a toner pattern on the surface. For toner density adjustment, the sensor 8 irradiates light to a predetermined area on the intermediate transfer belt 4, and detects its reflection light, and outputs an electrical signal corresponding to the detected intensity of the reflection light.

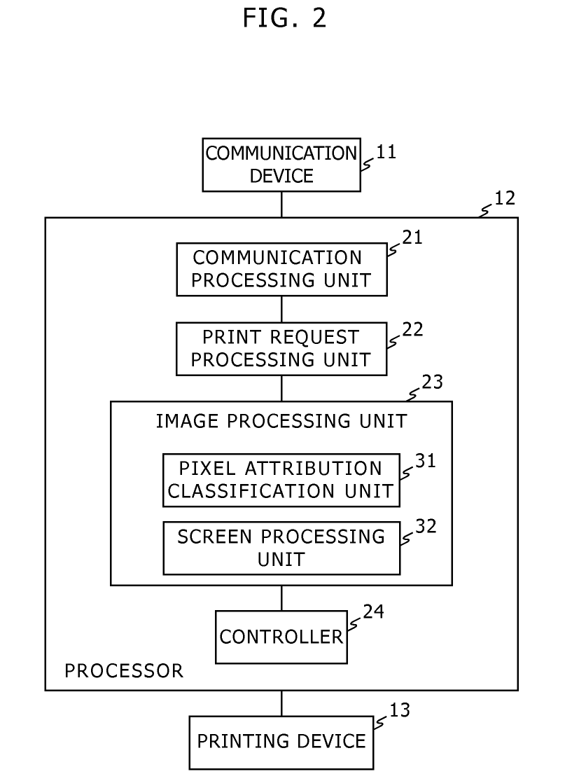

FIG. 2 is a block diagram that partially shows an electronic configuration of the image forming apparatus in Embodiment 1 according to this invention. The image forming apparatus has a communication device 11, a processor 12, and a printing device 13 in FIG. 2.

The communication device 11 is capable of connecting a host device through a network or a peripheral device interface, and performs data communication according to a predetermined communication protocol.

Further, the processor 12 is a computer that has a CPU (Central Processing Unit), a ROM (Read Only Memory), and a RAM (Random Access Memory). The processor 12 loads programs from a memory device (not shown) and/or the ROM into the RAM and executes the programs by the CPU in order to form various processing units.

Further, the printing device 13 is an internal device that prints a document image by the mechanical configuration shown in FIG. 1.

The processor 12 executes the programs appropriately after starting up the image forming apparatus. In this embodiment, the processor 12 forms processing units such as an operating system (not shown), a communication processing unit 21, a print request processing unit 22, an image processing unit 23 and a controller 24.

The communication processing unit 21 is a processing unit that executes data communication with a host device by controlling the communication device 11. For example, the communication processing unit 21 receives document data as a print request from the host device.

Further, the print request processing unit 22 receives a print request based on user operation through an operation panel of the image forming apparatus and a print request supplied from the host device, and performs print jobs corresponding to these requests. For example, the print request processing unit 22 generates image data from document data in a predetermined data format such as PDL (Page Description Language), PDF (Portable Document Format) upon receiving the document data as the print request from the host device. The image data is bitmap data. If bitmap data as the document data is received from the host device, the print request processing unit 22 uses the received bitmap data as the image data.

In addition, the image processing unit 23 executes a predetermined image process for the image data to generate print data (e.g. print image data generated by single-threshold conversion for each color). The image processing unit 23 has a pixel attribution classification unit 31 and a screen processing unit 32.

The pixel attribution classification unit 31 identifies a character area and a gradation area in the image data, for example, referring to attribution data of each pixel in the image data.

For the areas identified by the pixel attribution classification unit 31, the screen processing unit 32 performs a screen process of the area in the image data other than the character area by using the first dot growth pattern, and performs a screen process of the character area by using the second dot growth pattern different from the first dot growth pattern.

In Embodiment 1, the screen processing unit 32 applies dot growth along the second dot growth pattern by changing both the number of dots and dot intensity according to a pixel value in the image data. Moreover, in Embodiment 1, the screen processing unit 32 sets the dot intensity corresponding to the pixel value in the character area lower than the dot intensity corresponding to the same pixel value in the area (e.g. the gradation area, here) other than the character area.

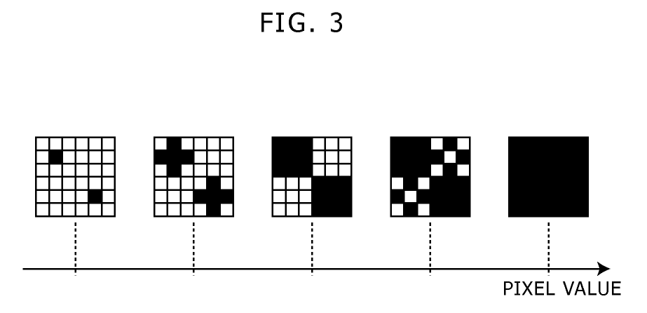

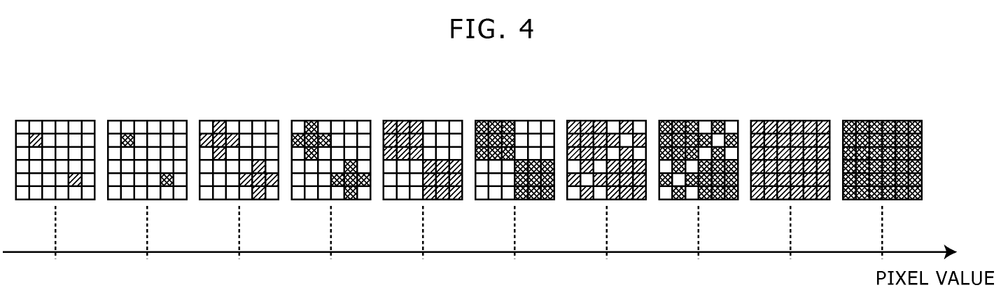

Further, in Embodiment 1, the screen processing unit 32 performs both the screen processes for the character area and for the area other than the character area with a same screen ruling and a same screen angle. The screen angle is the arrangement angle of dots (i.e. dot assembly) in the dot pattern such as shown in FIGS. 3 and 4.

FIG. 3 is a diagram that explains a relation between a pixel value in the image data and the print image data after the screen process of the first dot growth pattern in Embodiment 1 according to this invention. FIG. 4 is a diagram that explains a relation between a pixel value in the image data and the print image data after the screen process of the second dot growth pattern in Embodiment 1 according to this invention.

In the first dot growth, the number of dots increases along with the increase of a pixel value of the image data as shown in FIG. 3. In FIG. 3, the dot pattern in 6×6 pixels is set according to the pixel value of the 6×6 pixels. Here, the toner density of the dots (i.e. dot intensity) is constant. On the other hand, in the second dot growth pattern as shown in FIG. 4, the dot pattern is similar to that of the first dot growth method shown in FIG. 3, but the toner density of the dots is varied according to the pixel value. For example, referring to threshold values of a threshold matrix in the screen processing, when the pixel value is larger than the threshold value of a pixel in the matrix, a dot is formed on this pixel. The dot intensity is set corresponding to the difference between the pixel value and the smallest threshold value larger than the pixel value.

In Embodiment 1, the screen processing unit 32 is capable of changing an exposure period of beams from the exposure devices 2 to the photoconductor drums 1a to 1d pixel by pixel by using the controller 24, and changes the intensity of a dot in the character area by changing the exposure period of the pixel corresponding to the pixel value in the image data. Therefore, for each pixel which contains a dot, the screen processing unit 32 determines the exposure period (i.e. the length of the exposure period) based on the original pixel value (i.e. the pixel value in the image data) and provides data of the exposure period to the controller 24.

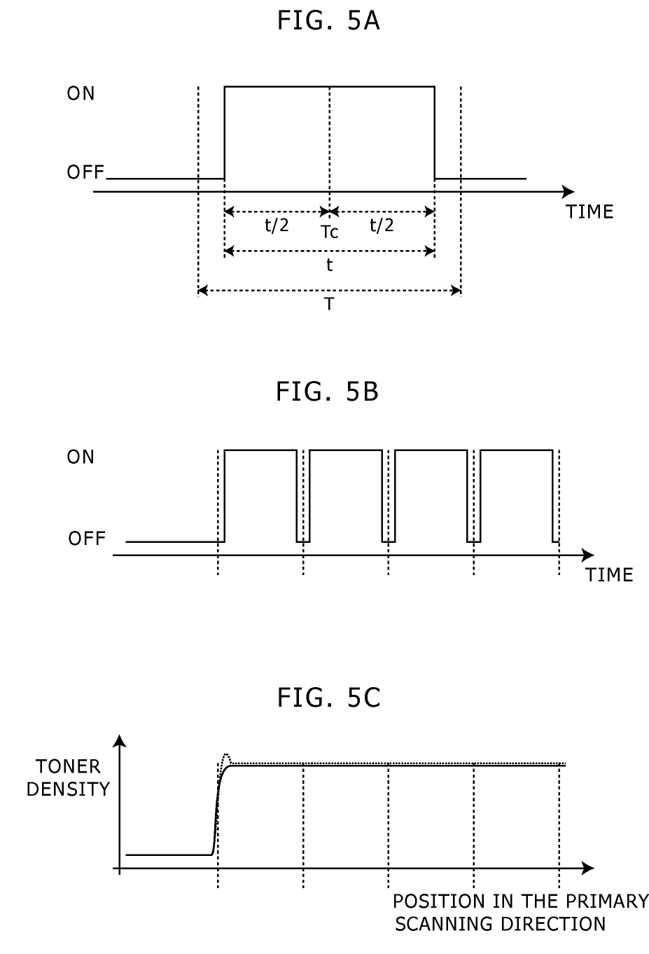

FIGS. 5A to 5C are diagrams that explain turning on and off the light irradiated by the exposure device 2 to the photoconductor drum 1a, 1b, 1c or 1d in Embodiment 1. In Embodiment 1, as shown in FIG. 5A, the length of the exposure period of a pixel with a dot in the character area is set shorter than a scanning period T for the whole pixel (for example, t is set as 90 percent of T at a maximum), and the exposure period is set in the center of the scanning period by the controller 24 according to the length of the exposure period determined by the screen processing unit 32. In other words, the center of the exposure period is set in the center of the scanning period Tc.

Therefore, the exposure period in the edge portion is controlled as shown in FIG. 5B. Consequently, the toner density of the edge portion is distributed as a solid line in FIG. 5C, for example. The edge effect is smaller than that in case of irradiating the beam in the whole scanning period (see a broken line in FIG. 5C).

Further, the controller 24 is a processing unit that monitors and controls internal devices such as the printing device 13. The controller 24 controls a driving source that drives the aforementioned rollers, a bias induction circuit that induces development biases and primary transfer biases, and the exposure devices 2 by using a processing circuit in order to perform developing, transferring and fixing the toner image, feeding a paper sheet, printing on the paper sheet, and outputting the paper sheet. The development biases are induced between the photoconductor drums 1a to 1d and the development units 3a to 3d, respectively. The primary transfer biases are induced between the photoconductor drums 1a to 1d and the intermediate transfer belt 4, respectively.

Hereinafter is explained the operation of the aforementioned image forming apparatus.

The print request processing unit 22 receives document data as a print request, and supplies image data corresponding to the document data to the image processing unit 23.

In the image processing unit 23, at first, the pixel attribution classification unit 31 identifies a character area and a gradation area in the image data, for example, referring to attribution data of each pixel in the image data.

The screen processing unit 32 performs the screen process of the area in the image data other than the character area by using the first dot growth pattern, and performs the screen process of the character area by using the second dot growth pattern different from the first dot growth pattern.

The controller 24 controls the printing device 13 to perform printing a print image based on the print image data obtained by the screen process of the screen processing unit 32. In printing the print image, the controller 24 causes the exposure devices 2 to irradiate beams to the photoconductor drums 1a to 1d. For each of four colors, the beam is irradiated throughout an exposure period on a pixel. For each pixel in the area other than the character area, the exposure period is identical to the scanning period of the pixel. For each pixel in the character area, the exposure period is determined by the screen processing unit 32.

As aforementioned, according to Embodiment 1, the pixel attribution classification unit 31 identifies a character area in the image data, and the screen processing unit 32 performs the screen process of the area other than the character area by using a dot growth pattern, and performs the screen process of the character area by using another dot growth pattern.

Therefore, performing the screen process of the character area by using a dot growth pattern suitable for characteristics of the character area, the toner consumption can be reduced without detecting any edge portions so as not to lower the quality of the print image

Further, according to Embodiment 1, the screen processing unit 32 sets the exposure period on the controller 24, and changes the dot intensity by changing the exposure period for a pixel in the character area according to a pixel value of the pixel.

If the exposure period is shortened, then electric charge of the electrostatic latent image is reduced and consequently, the toner density of each dot (i.e. dot intensity) decreases. Therefore, the toner consumption is reduced.

Furthermore, according to Embodiment 1, the length of the exposure period on a pixel in the character area is set shorter than a scanning period for the pixel, and the exposure period is set in the center of the scanning period by the screen processing unit 32.

As a result, the edge effect is controlled by decreasing electric charge of the electrostatic latent image at a dot edge of a dot located in the edge portion, and therefore the toner consumption can be reduced.

### Embodiment 2

In the image forming apparatus in Embodiment 2 according to this invention, the screen processes are performed for the character area and for the area other than the character area with different screen rulings.

The other configuration and the other behavior of the image forming apparatus in Embodiment 2 are identical to those in Embodiment 1, and therefore not explained here.

In Embodiment 2, the screen processing unit performs the screen process for the character area with the screen ruling higher than the screen ruling of the area other than the character area.

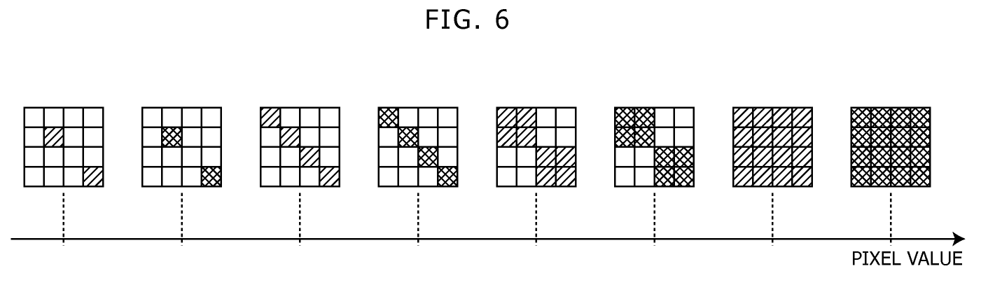

FIG. 6 is a diagram that explains a relation between a pixel value in the image data and the print image data after the screen process of the second dot growth pattern in Embodiment 2 according to this invention. For instance, in the first dot growth pattern for the area other than the character area, the screen process of dot growth pattern is performed as well as Embodiment 1, as shown in FIG. 3. On the other hand, in the second dot growth pattern for the character area, the screen process is performed using high screen ruling as shown in FIG. 6.

As aforementioned, according to Embodiment 2, the toner consumption can be reduced with controlling jaggies in the character area.

The description of the present invention has been presented for purposes of illustration and description, and is not intended to be exhaustive or limited to the invention in the form disclosed. Many modifications and variations will be apparent to those of ordinary skill in the art.

For instance, in the aforementioned embodiments, this invention is applied to a color image forming apparatus. Alternatively this invention obviously can be applied to a monochrome image forming apparatus.

What is claimed is:

1. An image forming apparatus, comprising:
a character-area identifying unit that identifies a character area in image data; and
a screen processing unit that performs a screen process of an area in the image data other than the character area by using a first dot growth pattern, and performs a screen process of the character area by using a second dot growth pattern different from the first dot growth pattern.

2. The image forming apparatus according to claim 1, wherein:
the screen processing unit applies dot growth along the second dot growth pattern by changing both the number of dots and dot intensity according to a pixel value in the image data.

3. The image forming apparatus according to claim 2, wherein:
the screen processing unit sets the dot intensity corresponding to a pixel value in the character area lower than the dot intensity corresponding to the same pixel value in the area other than the character area.

4. The image forming apparatus according to claim 2, further comprising:
a photoconductor;
an exposure device that scans a beam on the photoconductor to form an electrostatic latent image for toner development; and
a controller that controls light exposure of the beam from the exposure device to the photoconductor;
wherein the controller sets an exposure period of the beam, and the screen processing unit changes the dot intensity by changing the exposure period on a pixel in the character area according to a pixel value of the pixel.

5. The image forming apparatus according to claim 3, further comprising:
a photoconductor;
an exposure device that scans a beam on the photoconductor to form an electrostatic latent image for toner development; and
a controller that controls light exposure of the beam from the exposure device to the photoconductor;
wherein the controller sets an exposure period of the beam, and the screen processing unit changes the dot intensity by changing the exposure period on a pixel in the character area according to a pixel value of the pixel.

6. The image forming apparatus according to claim 4, wherein:
the length of the exposure period for a pixel in the character area is set shorter than a scanning period for the pixel, and the exposure period is set in the center of the scanning period.

7. The image forming apparatus according to claim 5, wherein:
the length of the exposure period for a pixel in the character area is set shorter than a scanning period for the pixel, and the exposure period is set in the center of the scanning period.

8. The image forming apparatus according to claim 1, wherein:
the screen processing unit performs both screen processes for the character area and for the area other than the character area with a same screen ruling.

9. The image forming apparatus according to claim 1, wherein:
the screen processing unit performs a screen process for the character area with a screen ruling higher than a screen ruling of the area other than the character area.

10. The image forming apparatus according to claim 1, wherein:
the screen processing unit performs both screen processes with the first dot growth pattern and with the second growth pattern with a same screen angle.

11. An image forming method, comprising the steps of:
(a) identifying a character area in image data; and
(b) performing a screen process of an area in the image data other than the character area by using a first dot growth pattern, and a screen process of the character area by using a second dot growth pattern different from the first dot growth pattern.
